(19) United States
(12) Patent Application Publication
(10) Pub. No.: US 2003/0078859 A1
(43) Pub. Date: Apr. 24, 2003

(54) Method and apparatus for interactive online modelling and evaluation of a product

(76) Inventors: Michael Roy Coke II, Troy, MI (US); Paula Yob Gwyn, Troy, MI (US)

Correspondence Address: BAKER BOTTS L.L.P., 2001 ROSS AVENUE, SUITE 600, DALLAS, TX, 75201-2980, US

(21) Appl. No.: 10/010,289

(22) Filed: Oct. 22, 2001

(51) Int. Cl. G06F 17/60

(52) U.S. Cl. 705/27

(57) ABSTRACT

A system for interactive online modelling and evaluation of a product works by transmitting an interface from a web server via data communications link to a user computer. The transmitted interface contains links to various product features which the user may modify by using the user computer. The request to modify a particular product feature, and more particularly, specific feature attributes, is transmitted to the server, and software components relating to such feature are transmitted back from the server and stored on the user computer. The user may then modify various feature attributes, and view the resulting modified product on a visual simulation interface segment. The modifications are subsequently gathered and stored on the server for evaluation. Additionally, user data may be collected, associated with the gathered data representing feature modifications, and also stored on the server for evaluation.

### BACKGROUND OF THE INVENTION

This invention relates to product modelling and evaluation, and more particularly, it relates to systems and methods for allowing users to modify product features directly on the internet in real time and share such designs with other internet users, wherein the modifications along with other user-specific attributes may be collected, recorded and evaluated by the internet server.

### DESCRIPTION OF THE RELATED ART

In recent years, there have been advances in the field of product design. A product's design increases its appeal to customers and enhances the customer's desire to own a product which is designed and tailored based on their needs or preferences. Since different customers typically have different preferences or needs, it is important both to include the customers in the design process, and to quickly learn the needs and preferences of different customer groups. For this reason, there have been attempts at increasing the functionality of modelling software and systems in order to provide various modelling options for the customers.

For example, automotive web sites offer different vehicle models from manufacturers' product lines with various features that typically can be ordered or previewed when a vehicle is purchased. Hence, the customer can choose the color, tires and the upholstery in the vehicle from a range of available options. The customer can also add other features to the basic model, such as CD/stereo equipment, air-conditioning, wider rims etc.

Sporting goods companies also have different product lines offered on their internet websites, wherein the customer can choose the item and choose different features offered for that item. For example, if the item is a golf shirt, the customer can choose between various shirts offered by a specific manufacturer, and then choose the size and the color.

Furthermore, home improvement companies offer web sites where customers can choose different products with different features from the company's product lines when remodelling or re-designing their homes. Based on a customer's inputs, various design options are offered, and the customer can choose between them. Once the desired design is chosen, a list of products necessary for completing the chosen design is provided to the customer.

Various design software programs have also been provided. For example, architectural and interior design software used by architectural and interior design companies offer the customer the choice of different home styles for a new home, or different components for re-designing different rooms in the house. The customers can provide comments, which allows the architects or designers to design the houses or rooms in such a way so as to increase their appeal to customers and satisfy the customers' needs and preferences.

As the above examples indicate, those involved with product design have recognized the importance of involving the customers in the design process. Indeed, some in this field have gone so far as to allow customers to “tailor” certain product features. For example, a shoe retailer may allow the customer to “tailor” certain shoe features, such as primary color, secondary color, lining color, cage color, mid-sole color, out-sole color and even a logo, to the customer's needs and preferences. The “tailoring” consists of choosing from a set of pre-determined options for each feature of a particular shoe design. The customer has a pre-determined number of options relating to primary color, secondary color etc. Hence, the customer has a limited opportunity to tailor the shoe by way of selecting a preferred option for each feature.

However, all prior art online modelling software is believed to suffer from a common drawback in that it fails substantially to allow the customers to modify the product features on a fully interactive basis, especially with respect to various feature attributes such as shape, three-dimensional location and appearance. Thus, the aforementioned online modelling software fails to involve the customer in the actual product design process and does not allow the customers to provide an immediate feedback with respect to their preferences and needs. Furthermore, the on-line modelling referred to above does not allow for collecting customer data and relating such data to the customers' design inputs in order to be evaluated by the internet server. Accordingly, there remains a need for an online modelling tool which permits the user to modify product features, especially feature attributes relating to shape, three-dimensional (3D) location, and appearance, and which allows such modifications to be recorded and related to recorded user data, thereby allowing for an evaluation of different customer groups' needs and preferences. The prior art is not believed to meet these needs.

### SUMMARY OF THE INVENTION

It is an object of the present invention, therefore, to enable the customers to actively participate in the product design process by providing real-time design inputs.

Another object of the invention is to allow the product developers to evaluate such design inputs and use the design preference data for purposes of product improvement or targeted marketing.

In order to meet these and other objects that will become apparent with reference to further disclosure set forth below, the present invention provides a method and system for interactive online modelling and evaluation of a product, for instance, through a website hosted on a server on behalf of a product vendor and made available to a prospective product customer at his remote user computer. The present invention works by transmitting an interface from the web server to the user computer which contains links to various product features that may be modified. Through the user computer, the customer may choose a set of product features that may be used as default features in the product design. Alternatively, the default features may be provided by the server. Subsequently, the customer may, by using the user computer, choose to modify one or more product features from the default set. The request to modify a particular product feature is transmitted to the web server, from which one or more software components relating to this product feature are transmitted to the user computer. The customer is then allowed to select and modify one or more attributes of the chosen feature and view a simulation of the product incorporating the feature modifications on the downloaded interface.

In one embodiment of the present invention, the customer is allowed to modify one or more attributes of the chosen feature, where at least one attribute is relating to the feature's shape, 3D location or appearance.

In another embodiment of the present invention, all of the feature modifications are transmitted to the web server and recorded.

In yet another embodiment of the present invention, pre-determined user data are collected from the customer.

In still another embodiment of the present invention, the collected customer data are related to the user's demographics.

In yet another embodiment of the present invention, the collected user data are recorded on the server.

In still another embodiment of the present invention, the recorded user data and the corresponding recorded feature modifications are combined and evaluated.

### BRIEF DESCRIPTION OF THE DRAWINGS

The accompanying drawings, which are incorporated and constitute part of this disclosure, illustrate preferred embodiments of the invention and serve to explain the principles of the invention.

FIG. 1 is a block diagram of a system for online modelling and evaluation in accordance with the invention.

FIG. 2 is an illustrative diagram presenting the methodology for online modelling and evaluation in accordance with the invention.

FIG. 3 is an illustrative diagram presenting an exemplary interface downloaded from a server with a set of features and modification links.

FIG. 4 is an exemplary user interface with a simulation window for car modelling and evaluation.

### DETAILED DESCRIPTION OF EXEMPLARY EMBODIMENTS OF THE INVENTION

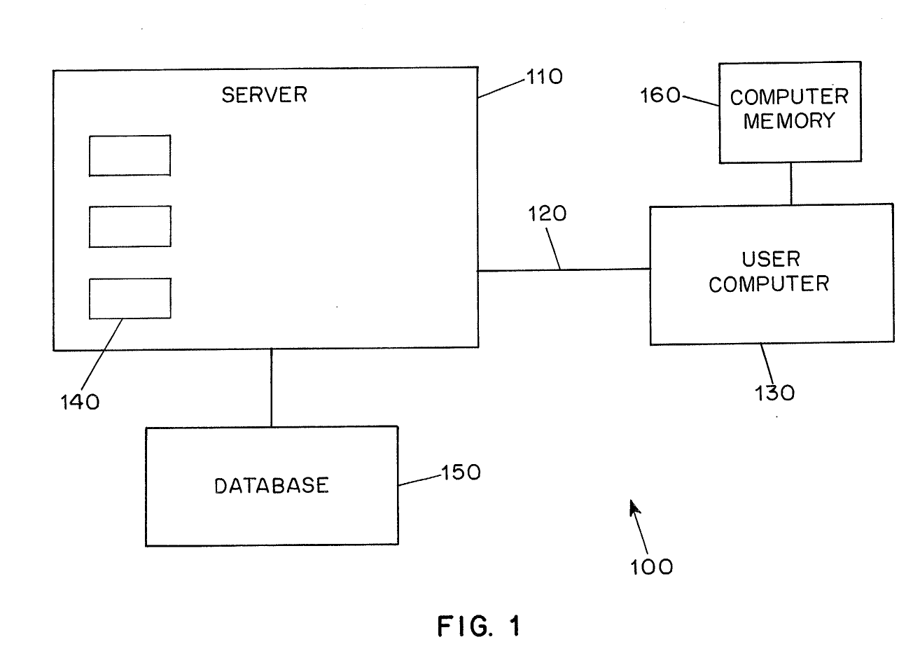

With reference to FIG. 1, an exemplary embodiment of the present invention will now be described. A system 100 for interactive online modelling and evaluation of a product is illustrated. The system 100 includes a website hosted on a server 110 on behalf of a product designer, vendor or manufacturer, which website is made available to a prospective product customer at his remote user computer 130. It also includes a data communications link 120 for communication between the web server 110 and the user computer 130. The system 100 works by transmitting an interface (not shown) from the web server 110 via data communications link 120 to the user computer 130. The transmitted interface contains links to various product features which may be modified by the user. Through the user computer 130, the customer may choose a set of product features which may be used as default features in the product design. Alternatively, the default features may be provided automatically by the server 110. Subsequently, the customer may, by using the user computer 130, choose to modify one or more product features from the default set. The request to modify a particular product feature is transmitted via the data communications link 120 to the web server 110, from which one or more software components 140 relating to various attributes of the chosen product features are transmitted to the user computer 130. The software components 140 are stored on a computer memory 160, from where they are retrieved when the user chooses to modify one or more attributes. The user is also allowed to view a simulation of the product incorporating the feature modifications on the downloaded interface.

In a preferred embodiment, all feature modifications are transmitted to the web server 110 via data communications link 120 and recorded on a database 150. The feature modifications are then available to the product vendors, designers or manufacturers for evaluation in order to determine the users' needs and preferences.

The user may be allowed to modify one or more attributes of the chosen feature, where at least one attribute is relating to the feature's shape, three-dimensional (3D) location or appearance. As the customer modifies the attributes, such modifications are recorded on the server database 150 via data communications link 120 and offered to the product designer, vendor or manufacturer for evaluation.

In a preferred embodiment, the interface, which is transmitted to the user computer 130 from the web server 110, is capable of collecting pre-determined user data. As the user enters the information pertaining to user's demographics and other information of interest to the product vendor, designer or manufacturer, the information is transmitted back to the server 110 via the data communications link 120 and stored on the server database 150. The obtained user information is then associated with the feature modifications made by this particular user, which allows the product vendors, designers and manufacturers to discern the needs and preferences of a particular demographic group in order to design, manufacture and provide different customer groups with the products that best fit their needs and preferences.

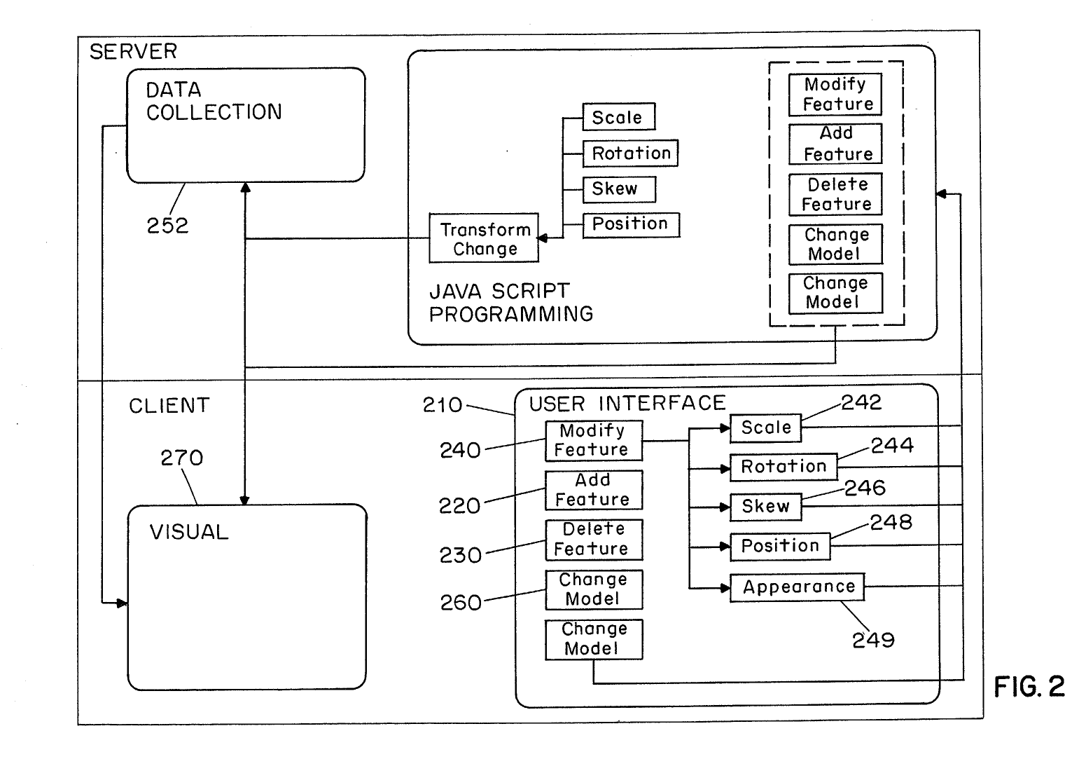

FIG. 2 depicts an illustrative diagram presenting the methodology for online modelling and evaluation in accordance with the invention. When the user requests from a server 110 (FIG. 1) an interface 210 for communication with the server 110, the interface 210 is downloaded from the server 110 to the user computer 130 via the data communications link 120. The interface 210 is capable of showing a plurality of pre-determined features available for modification. The user can then request one or more of such features from the server 110. Subsequently, the user computer 130 receives from the server 110 one or more software components 140 relating to the features selected for modification. The software components 140 include various attributes associated with the features selected for modification, which attributes may be modified.

The interface 210 is capable of permitting the user to modify the design of the product in various ways. For example, the user may be allowed to add features 220, delete features 230 or even modify features 240. The features may be modified by modifying one or more attributes associated with the feature. For example, the feature may be scaled 242, rotated 244 or even skewed 246. Furthermore, the feature's three-dimensional (3D) location in the product may be changed 248, or even its appearance, including color pattern, may be altered 249.

The interface 210 is further capable of enabling the user to view the product with all the feature modifications that have been made. In that respect, the user can view a simulation of the product incorporating the scaled, rotated or skewed features via a visual simulation interface segment 270. The user can also view a simulation of the product with the added features, or without the deleted features, on the visual simulation interface segment 270. In case the user is not satisfied with the modifications that were made, the user can further modify the chosen features or even choose a different set of features to be modified. In case the user is not satisfied with a default model having a pre-determined set of features, which may be initially displayed, the user is also enabled to change a product model 260, namely, a default product that is initially simulated with a pre-determined set of features, one or more of which may be modified at the user's request. Once the user is satisfied with the product design, the modifications pertaining to such design are transmitted to the server 110 where the data from different users are collected 252 and stored on the server memory 150.

The gathered and stored data depict consumer preference. As said before, pre-determined user data also may be collected and associated with the gathered data representing the feature modifications. From this set of associated data, consumer preference of a particular consumer group may be discerned and the product design may be altered in response to such discerned consumer preference. In some instances, gathered data may be available in real-time to product designers for review and evaluation. Alternatively, gathered data may be statistically organized based on a pre-determined set of parameters to discern consumer preference. For example, product designers may statistically organize age data and the corresponding gathered data representing feature modifications to determine preferred designs for different age groups. The product designers may also statistically organize gender data, user income data and corresponding gathered data representing feature modifications to discern particular preferences of, for example, middle-income women.

Gathered data may also be scientifically integrated in the product design process. For example, gathered data may be used to alter product design based on discerned consumer preference. Furthermore, gathered data may be used for end-stream customer-specific modifications of the product design. It also may be used for mid-stream modifications of an in-progress product design. Naturally, the gathered data may be used to provide a basis for professional product design by providing an initial model representing the discerned customer preferences.

In addition, gathered data may be used by product vendors in a marketing process. For example, the data may be used by the vendors to develop a marketing strategy targeted to specific customer groups. Since the preferences of different customer groups may be discerned from the gathered data, a targeted marketing may be developed.

Gathered data may also be used by product manufacturers in a manufacturing process. The customer preferences are discerned from gathered data, the design of the manufactured product may be modified based on such preferences, and the manufacturers may consequently modify the production lines to incorporate the modifications representing the consumer preferences. These modifications in the manufacturing process may be made at any time.

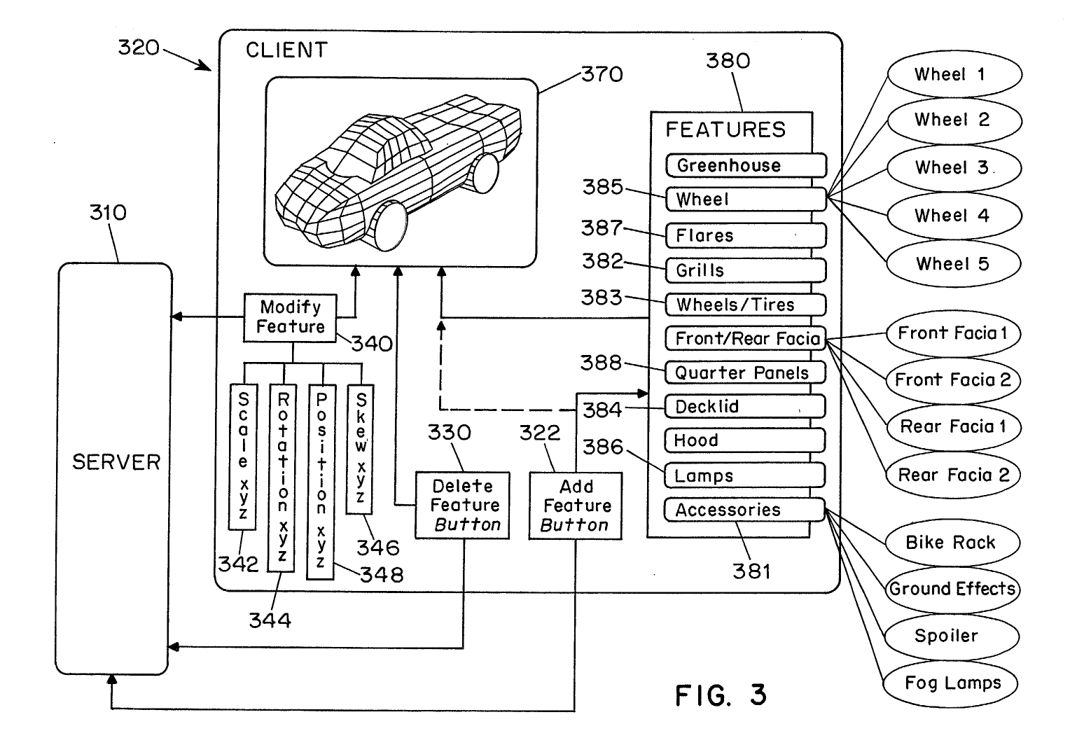

In FIG. 3, an exemplary interface 320 downloaded from the server 310 with a set of features and modification links is illustrated. As said before, when the user requests from the server 310 an interface for communication with the server 310, the interface 320 is downloaded from the server 310 to the user computer. In this exemplary embodiment, the interface 320 has a visual simulation interface segment 370, which initially may display a default car model and subsequently present the user's design, and a set of feature links 380 which the user can use during the car design session.

The user may choose to add certain features by clicking on an “add feature” button 322. Once the user clicks on the “add feature” button 322, the user is directed to the set of feature links 380, where one or more features to be added can be chosen. For example, the user can choose to add different accessories 381, grills 382, wheels/tires 383 or a decklid 384. Once the features to be added are chosen, the software components 140 (see FIG. 1) relating to the chosen features are downloaded from the server 310. The software components include various attributes relating to each particular feature. For example, if the user chooses a feature “wheel” 385, various software components representing wheel attributes such as rim size, shape, three-dimensional (3D) location of the wheel, etc., are downloaded from the server, and the user may choose the wheel having the desired attributes to be added in the design. Similarly, if the user chooses the feature “accessories” 381, various software components representing different accessories, such as bike rack, spoiler, fog lamps, and ground effects, and their attributes (size, color, shape, location etc) are downloaded from the server to the user computer. The user is then allowed to choose the particular accessory having the desired attributes to be added to the design.

The user also may choose to delete certain features by clicking on a “delete feature” button 330. Once the user clicks on the “delete feature” button 330, the user is directed to the set of feature links 380, where one or more features to be deleted can be chosen. For example, the user can choose to delete lamps 386, flares 387, or even quarterpanels 388. Once the features to be deleted are chosen, they are erased from the simulation viewed at the visual simulation interface segment 370. It should be noted that the user may be able to click on a particular feature to be deleted directly on the visual simulation interface segment 370 and then click on the “delete feature” button 330 to effect the feature deletion.

The user may also choose to modify one or more car features by modifying their attributes. Once the user chooses the particular features to be modified, the user can click on a modify feature button 340, where various modification tools are offered. For example, the user may be allowed to click on a “scale” button 342, which would allow the user to modify the size of the chosen feature. The user also may be allowed to skew the feature by clicking on the “skew” button 346. The user further may be allowed to rotate the feature by clicking on the “rotate” button 344. The user additionally may be allowed to change the default 3D location of the chosen feature by clicking on a “position” button 348.

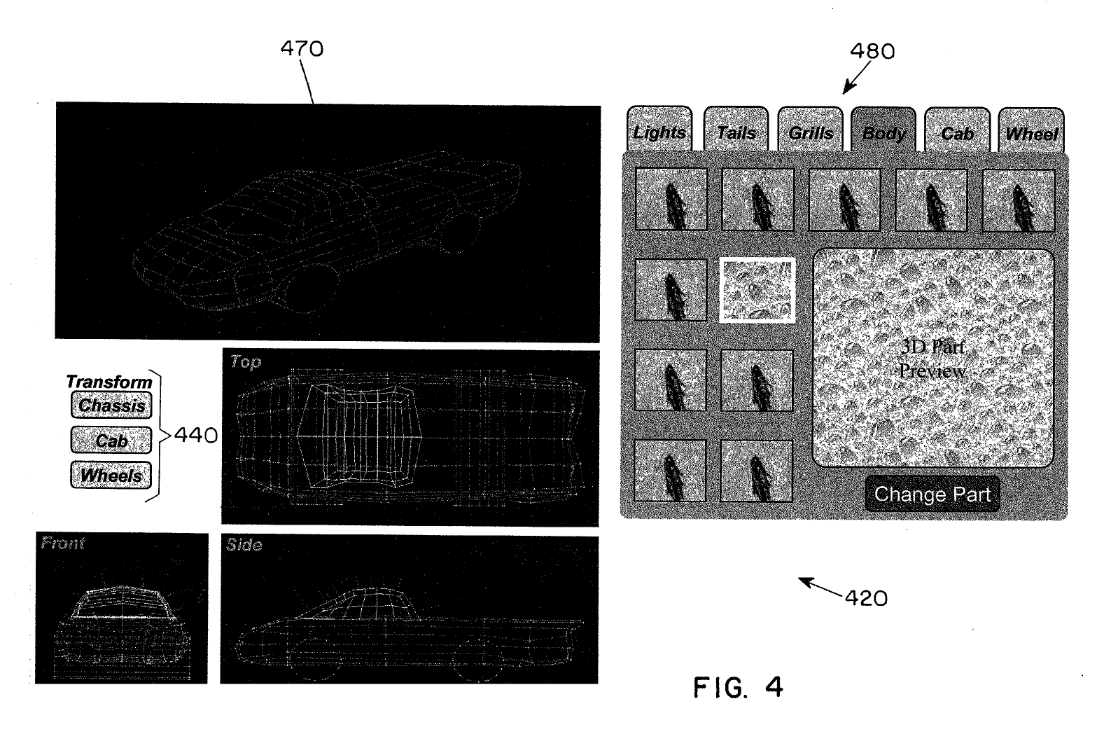

The user can view a final simulation of the car incorporating all added and modified features via the visual simulation interface segment 370. The visual simulation interface segment 370 is capable of allowing a 360-degree view of the simulated car. It should be noted that while the user is adding, deleting, and modifying different chosen features, all those changes are recorded on the server 310. While the visual simulation interface segment 370 allows for a 360-degree view of the product, it may be important for the users to view the simulation from different sides of the product at the same time, in order to better determine whether the feature modifications are satisfactory. An interface incorporating a plurality of visual simulation interface segments is shown in FIG. 4.

FIG. 4 illustrates a car-design user interface incorporating a plurality of visual simulation interface segments presenting different views of the car. The interface 420 has a set of feature links 480 and a plurality of visual simulation interface segments 470. In this exemplary interface 420, the visual simulation interface segments 470 represent the top, front, side and three-dimensional views of the car. The interface 420 also includes a set of feature modification buttons 440, such as chassis, cab, and wheel modification buttons. As the user chooses particular features and modifies their attributes, the car simulations incorporating such modifications are simultaneously displayed on each of the visual simulation interface segments 470, thus allowing the user to view the car modifications from different angles. The different angle views enable the user to determine whether the chosen modifications satisfy the user's preferences and needs.

It is to be appreciated that these techniques and network configurations can also be applied in industries other than the auto industry. For example, sports equipment designers can use these techniques to collect and evaluate data relating to various sports equipment. Moreover, these techniques and network configurations may be used in any industry where the product design is a part of the product's development and/or manufacturing processes.

The foregoing merely illustrates the principles of the invention by reference to exemplary embodiments thereof. Various modifications and alterations to the described embodiments will be apparent to those skilled in the art in view of the teachings herein. It will thus be appreciated that those skilled in the art will be able to devise numerous techniques which, although not explicitly shown or described herein, embody the principles of the invention and are thus within the spirit and scope of the invention.

What is claimed is:

1. A method for providing interactive online modelling and evaluation of a product having one or more features, comprising the steps of:
a. downloading from a server an interface for communication with said server;
b. allowing a customer to choose one or more features from a predetermined set of features relating to the product;
c. downloading from the server one or more software components relating to each chosen feature;
d. allowing the customer to modify at least one of said chosen features of the product by use of the related software component; and
e. presenting to the customer for viewing a simulation of the product incorporating said at least one feature modification.

2. A method for providing interactive online modelling and evaluation of a product having one or more features, comprising the steps of:
a. downloading from a server an interface for communication with said server;
b. allowing a customer to choose one or more features from a predetermined set of features relating to the product;
c. downloading from said server one or more software components relating to each chosen feature;
d. allowing the customer to modify at least one attribute of said one or more chosen features by use of the related software component, wherein said at least one attribute relates to one of shape, three-dimensional location and appearance; and
e. presenting to the customer for viewing a simulation of the product incorporating said at least one feature modification.

3. A method for providing interactive online modelling and evaluation of a product having one or more features, comprising the steps of:
a. downloading from a server an interface for communication with said server;
b. allowing a customer to choose one or more features from a predetermined set of features relating to the product;
c. downloading from said server one or more software components relating to each chosen feature;
d. allowing the customer to modify at least one of the chosen features of the product by use of the related software component;
e. presenting to the customer for viewing a simulation of the product incorporating said at least one feature modification; and
f. recording said at least one feature modification on the server.

4. The method of claim 3, further comprising the step of collecting pre-determined user data from the user.

5. The method of claim 4, wherein said user data relate to the user's demographics.

6. The method of claim 3, further comprising the step of recording said user data on the server.

7. The method of claim 6, further comprising the step of relating said recorded at least one feature modification to said recorded user data for evaluation.

8. A method for obtaining interactive online modelling and evaluation, comprising the steps of:
a. requesting from a server an interface for communication with said server;
b. requesting from said server one or more features from a predetermined set of features relating to the product;
c. receiving one or more software components relating to each requested feature on a user computer;
d. modifying at least one of said one or more features by use of the related software feature; and
e. viewing a simulation of the product incorporating said at least one feature modification.

9. A method for obtaining interactive online modelling and evaluation, comprising the steps of:
a. requesting from a server an interface for communication with said server;
b. requesting from said server one or more features from a predetermined set of features relating to the product;
c. receiving one or more software components relating to each requested feature on a user computer;
d. modifying at least one attribute of said one or more requested features by use of the related software feature, wherein said at least one attribute relates to one of shape, three-dimensional location and appearance; and
e. viewing a simulation of the product incorporating said at least one feature modification.

10. A method for obtaining interactive online modelling and evaluation, comprising the steps of:
a. requesting from a server an interface for communication with said server;
b. requesting from said server one or more features from a predetermined set of features relating to the product;
c. receiving one or more software components relating to each requested feature on a user computer;
d. modifying at least one attribute of said one or more requested features by use of the related software feature, wherein said at least one attribute relates to one of shape, three-dimensional location and appearance; and
e. viewing a simulation of the product incorporating said at least one feature modification, wherein said simulation is available to the server for evaluation.

11. A method for obtaining interactive online modelling and evaluation, comprising the steps of:
a. requesting from a server an interface for communication with said server;
b. requesting from said server one or more features from a predetermined set of features relating to the product;
c. receiving one or more software components relating to each requested feature on a user computer;
d. modifying at least one attribute of said one or more requested features by use of the related software feature, wherein said at least one attribute relates to one of shape, three-dimensional location and appearance;
e. viewing a simulation of the product incorporating said at least one feature modification; and
f. recording said at least one feature modification on the server.

12. The method of claim 11, further comprising the step of collecting a pre-determined user data from the user.

13. The method of claim 12, wherein said user data relate to the user's demographics.

14. The method of claim 11, further comprising the step of recording said user data on the server.

15. The method of claim 14, further comprising the step of relating said recorded at least one feature modification to said recorded user data to determined user needs and preferences.

16. A system for interactive online modelling and evaluation, comprising:
a. a web server programmed with downloadable software components, said server being configured to receive requests;
b. a connection to a data communications link, operationally coupled with said server, configured to transmit requests; and
c. at least one computer memory connected to said web server, wherein said web server is supplied with programming in conjunction with said at least one computer memory, wherein said programming is operational
i. to download from a server an interface for communication with said server;
ii. to allow a customer to choose one or more features from a pre-determined set of features relating to the product;
iii. to download from said web server one or more downloadable software components relating to each chosen feature;
iv. to allow the customer to modify at least one of the chosen features of the product by use of the related software component; and
v. to allow the customer to view a simulation of the product incorporating at least one feature modification.

17. A system for interactive online modelling and evaluation, comprising:
a. a web server programmed with downloadable software components, said server being configured to receive requests;
b. a connection to a data communications link, operationally coupled with said server configured to transmit requests; and
c. at least one computer memory connected to said web server, wherein said web server is supplied with programming in conjunction with said at least one computer memory, wherein said programming is operational
i. to download from a server an interface for communication with said server;
ii. to allow a customer to choose one or more features from a pre-determined set of features relating to the product;
iii. to download from said web server one or more downloadable software components relating to each chosen feature;
iv. to allow the customer to modify at least one attribute of the chosen features of the product by use of the related software component, wherein said at least one attribute relates to one of shape, three-dimensional location and appearance; and
v. to allow the customer to view a simulation of the product incorporating at least one feature modification.

18. A system for interactive online modelling and evaluation, comprising:
a. a web server programmed with downloadable software components, said server being configured to receive requests;
b. a connection to a data communications link, operationally coupled with said server configured to transmit requests; and
c. at least one computer memory connected to said web server, wherein said web server is supplied with programming in conjunction with said at least one computer memory, wherein said programming is operational
i. to download from a server an interface for communication with said server;
ii. to allow a customer to choose one or more features from a pre-determined set of features relating to the product;
iii. to download from said web server one or more downloadable software components relating to each chosen feature;
iv. to allow the customer to modify at least one of the chosen features of the product by use of the related software component;
v. to allow the customer to view a simulation of the product incorporating at least one feature modification; and
vi. to record said at least one feature modification on the server.

19. The system of claim 18, wherein said web server is programmed to collect a pre-determined user data from the user.

20. The system of claim 19, wherein said user data relate to the user's demographics.

21. The system of claim 18, wherein said web server is programmed to record said user data on the server.

22. The system of claim 21, wherein said web server is programmed to associate said recorded at least one feature modification to said recorded user data for evaluation.

23. A system for interactive online modelling and evaluation, comprising:
a. a computer processor;
b. a network communication link between a server and a user connected to said computer processor; and
c. at least one computer memory operationally coupled with said computer processor, wherein said computer processor is supplied with programming in conjunction with said computer memory, wherein said programming is operational
i. to request from a server an interface for communication with said server;
ii. to request from said server one or more features from a predetermined set of features relating to the product;
iii. to receive one or more software components relating to each requested feature on a user computer;
iv. to modify at least one of said one or more features by use of the related software component; and
v. to generate a simulation of the product incorporating said at least one feature modification.

24. A system for interactive online modelling and evaluation, comprising:
a. a computer processor;
b. a network communication link between a server and a user connected to said computer processor; and
c. at least one computer memory operationally coupled with said computer processor, wherein said computer processor is supplied with programming in conjunction with said computer memory, wherein said programming is operational
i. to request from a server an interface for communication with said server;
ii. to request from said server one or more features from a predetermined set of features relating to the product;
iii. to receive one or more software components relating to each requested feature on a user computer;
iv. to modify at least one attribute of said one or more requested features by use of the related software component, wherein said at least one attribute relates to one of shape, three-dimensional location and appearance; and
v. to generate a simulation of the product incorporating said at least one feature modification.

25. A system for interactive online modelling and evaluation, comprising:
a. a computer processor;
b. a network communication link between a server and a user connected to said computer processor; and
c. at least one computer memory operationally coupled with said computer processor, wherein said computer processor is supplied with programming in conjunction with said computer memory, wherein said programming is operational
i. to request from a server an interface for communication with said server;
ii. to request from said server one or more features from a predetermined set of features relating to the product;
iii. to receive one or more software components relating to each requested feature on a user computer;
iv. to modify at least one attribute of said one or more requested features by use of the related software component, wherein said at least one attribute relates to one of shape, three-dimensional location and appearance; and
v. to generate a simulation of the product incorporating said at least one feature modification, wherein said simulation is available to the server for evaluation.

26. A system for interactive online modelling and evaluation, comprising:
a. a computer processor;
b. a network communication link between a server and a user connected to said computer processor; and
c. at least one computer memory operationally coupled with said computer processor, wherein said computer processor is supplied with programming in conjunction with said computer memory, wherein said programming is operational
i. to request from a server an interface for communication with said server;
ii. to request from said server one or more features from a predetermined set of features relating to the product;
iii. to receive one or more software components relating to each requested feature on a user computer;
iv. to modify at least one attribute of said one or more requested features by use of the related software component, wherein said at least one attribute relates to one of shape, three-dimensional location and appearance;
v. to generate a simulation of the product incorporating said at least one feature modification; and
vi. to record said at least one feature modification on the computer processor.

27. The system of claim 26, wherein said computer processor is programmed to collect a pre-determined user data from the user.

28. The system of claim 27, wherein said user data relate to the user's demographics.

29. The system of claim 26, wherein said computer processor is programmed to transmit said user data to the server.

30. The system of claim 29, wherein said computer processor is programmed to relate said user data to said at least one feature modification for evaluation.

31. A method for altering design of a consumer product in response to consumer preference, wherein consumer preference as to product features is discerned through online survey, comprising the steps of:
a. making available to a plurality of consumers an interactive online mock-up for a consumer product having a plurality of product features;
b. allowing each of the plurality of consumers to modify at least one of the features to express the customer's design preference;
c. gathering data associated with said at least one feature modification; and
d. making available to a product designer said gathered data for evaluation.

32. The method of claim 31, wherein the product designer has real-time access to said gathered data.

33. The method of claim 31, further comprising the step of statistically organizing said gathered data based on a pre-determined set of parameters to discern consumer preference.

34. The method of claim 31, wherein said gathered data representing consumer preference are scientifically integrated in a product design process.

35. The method of claim 34, wherein said gathered data are used to alter a product design of a product based on discerned consumer preference.

36. The method of claim 34, wherein said gathered data representing consumer preference are used by a product designer for end-stream customer-specific modifications of the product design.

37. The method of claim 34, wherein said gathered data are used by the product designer for mid-stream modifications of an in-progress product design.

38. The method of claim 34, wherein said gathered data are used by the product designer to obtain an initial user-specific design in a design process.

39. The method of claim 34, wherein said gathered data are used by a product vendor to perform real-time modifications in a product marketing process.

40. The method of claim 34, wherein said gathered data are used by a product manufacturer to replace a current manufacturing design with a design whose features incorporate data relative to said modifications of at least one of said features collected from the plurality of customers.

41. The method of claim 34, wherein said gathered data representing consumer preference are used by the product manufacturer to perform real-time changes in a product-manufacturing process.
